(19) United States
(12) Patent Application Publication
(10) Pub. No.: US 2025/0350715 A1
(43) Pub. Date: Nov. 13, 2025

(54) IMAGING DEVICE, IMAGING METHOD, AND IMAGING SYSTEM

(71) Applicant: Panasonic Intellectual Property Management Co., Ltd., Osaka (JP)

(72) Inventor: Koji SHIBUNO, Osaka (JP)

(73) Assignee: Panasonic Intellectual Property Management Co., Ltd., Osaka (JP)

(21) Appl. No.: 19/199,472

(22) Filed: May 6, 2025

(30) Foreign Application Priority Data
May 9, 2024 (JP) 2024-076364

(51) Int. Cl. H04N 13/296; H04N 13/257; H04N 23/12; H04N 23/63; H04N 25/11

(52) U.S. Cl. CPC H04N 13/296; H04N 13/257; H04N 23/12; H04N 23/631; H04N 25/11

(57) ABSTRACT

An imaging device includes: a spectroscopic element that disperses incident light into more than three plurality of wavelength bands; an image sensor that captures a subject image via the spectroscopic element to generate image data; an input interface that receives first selection information indicating a first wavelength band selected by a user from the plurality of wavelength bands; and a controller. The controller adjusts exposure based on a luminance value of a piece of image information that is included in multispectral image data and corresponds to the first wavelength band, the multispectral image data including pieces of image information corresponding to the plurality of wavelength bands, respectively.

### TECHNICAL FIELD

The present disclosure relates to an imaging device, an imaging method, and an imaging system that handle multispectral image data.

### BACKGROUND ART

WO 2022/176621 A discloses an imaging system using a technique of compressed sensing. The imaging system described in WO 2022/176621 A generates a restoration table determined based on a spatial distribution of transmission spectra of a plurality of types of filters and generates, based on image data, hyperspectral image data including images corresponding to four or more bands included in a target wavelength band. WO 2022/176621 A discloses that an imaging system corrects the restoration table, thereby facilitating calibration of an imaging device.

### SUMMARY

The present disclosure provides an imaging device, an imaging method, and an imaging system that can achieve an appropriate exposure for an image desired by a user in an image of more than three plurality of wavelength bands.

An imaging device according to one aspect of the present disclosure includes:
a spectroscopic element that disperses incident light into more than three plurality of wavelength bands;
an image sensor that captures a subject image via the spectroscopic element to generate image data;
an input interface that receives first selection information indicating a first wavelength band selected by a user from the plurality of wavelength bands; and a controller that adjusts exposure based on a luminance value of a piece of image information that is included in multispectral image data and corresponds to the first wavelength band, the multispectral image data including pieces of image information corresponding to the plurality of wavelength bands, respectively.

An imaging method according to one aspect of the present disclosure includes:
generating image data by capturing a subject image via a spectroscopic element that disperses incident light into more than three plurality of wavelength bands;
receiving selection information indicating a first wavelength band selected by a user from the plurality of wavelength bands; and
adjusting exposure based on a luminance value of a piece of image information that is included in multispectral image data and corresponds to the first wavelength band, the multispectral image data including pieces of image information each corresponding to one of the plurality of wavelength bands.

An imaging system according to one aspect of the present disclosure includes:
an imaging device; and
an image processing device communicably connected to the imaging device,
the imaging device including:
   a spectroscopic element that disperses incident light into more than three plurality of wavelength bands;
   an image sensor that captures a subject image via the spectroscopic element to generate image data;
   a communication interface that sends the image data to the image processing device;
   an input interface that receives first selection information indicating a first wavelength band selected by a user from the plurality of wavelength bands; and
   a controller that adjusts exposure,
wherein the image processing device generates, based on the image data received from the imaging device, multispectral image data including pieces of image information each corresponding to one of the plurality of wavelength bands and transmits the multispectral image data to the imaging device, and
the controller adjusts the exposure based on a luminance value, of the multispectral image data, corresponding to the first wavelength band.

The present disclosure makes it possible to achieve appropriate exposure for an image desired by a user in an image of more than three plurality of wavelength bands.

### BRIEF DESCRIPTION OF DRAWINGS

FIG. 1 is a block diagram illustrating a configuration example of an imaging system according to a first embodiment;

FIG. 2 is a schematic diagram illustrating an example of a configuration of a hyperspectral filter;

FIG. 3 is a diagram illustrating an example of transmittance, of the hyperspectral filter, for light in each of a plurality of wavelength bands included in incident light that is incident on the hyperspectral filter;

FIG. 4 is a graph illustrating a relationship between wavelength and luminance of incident light that is incident on the hyperspectral filter;

FIG. 5 is a diagram for describing wavelength dependency of a focus position of a focus lens;

FIG. 6 is a sequence diagram for describing an operation of the imaging system according to the first embodiment;

FIG. 7 is a diagram illustrating an example of a display screen displayed on a display;

FIG. 8 is an enlarged view of the wavelength band table illustrated in FIG. 7;

FIGS. 9A to 9C are diagrams each illustrating an example of the display screen displayed on the display;

FIGS. 10A to 10C are diagrams each illustrating an example of the display screen displayed on the display; and

FIG. 11 is a block diagram illustrating a configuration example of a hyperspectral camera according to a first modification.

### DETAILED DESCRIPTION

Hereinafter, an embodiment will be described in detail with reference to the drawings as appropriate. However, unnecessarily detailed description is omitted in some cases. Note that the accompanying drawings and the following description are provided in order for a person skilled in the art to fully understand the present disclosure and are not intended to limit subject matters recited in the claims.

### First Embodiment

### 1. Configuration

### 1-1. Hyperspectral Camera

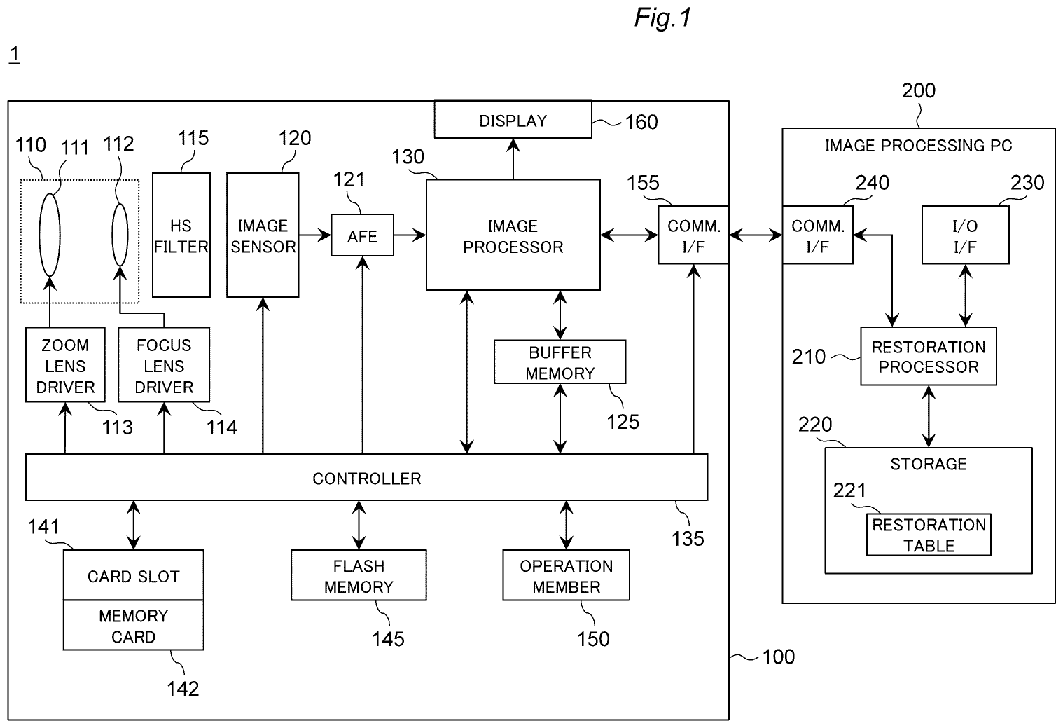

FIG. 1 is a block diagram illustrating a configuration example of an imaging system 1 according to a first embodiment of the present disclosure. The imaging system 1 includes a hyperspectral camera 100 and an image processing PC 200. The hyperspectral camera 100 captures a subject image to generate image data. The image data generated by the hyperspectral camera 100 includes moving image data and still image data.

The hyperspectral camera 100 captures, by the image sensor 120, a subject image formed via an optical system 110 and the hyperspectral filter 115. The hyperspectral camera 100 digitizes, by an analog front end (AFE) 121, an image signal generated by the image sensor 120 to generate original image data (RAW image data), and performs various types of processing on the RAW image data to generate image data. The image sensor 120 and the AFE 121 are an example of an imaging unit of the present disclosure.

A controller 135 can transmit, via a communication interface 155, the RAW image data or image data generated by an image processor 130 to the image processing PC 200. The controller 135 may record the image data in a flash memory 145 or a memory card 142 inserted in a card slot 141. The controller 135 can display (reproduce) the image data recorded in the flash memory 145 or the memory card 142, on a display 160 in accordance with an operation of the operation member 150 by a user.

The optical system 110 includes a zoom lens 111 and a focus lens 112. The optical system 110 may include an optical camera-shake correction lens (OIS), an aperture diaphragm, a shutter, and the like.

The zoom lens 111 is a lens for changing a magnification ratio of a subject image formed by the optical system. The zoom lens 111 is configured with one or more lenses. The zoom lens 111 is driven by a zoom lens driver 113. The zoom lens driver 113 moves the zoom lens 111 along an optical axis direction of the optical system in accordance with control of the controller 135. The zoom lens driver 113 may include a zoom lever, a zoom drive switch, and an actuator or a motor. The zoom lens 111 may be driven by a zoom ring. The user can perform a zooming operation by manually (not electrically) moving the zoom lens 111 by rotating the zoom ring.

The focus lens 112 is a lens for changing a focusing state of the subject image formed on the image sensor 120. The focus lens 112 is configured with one or more lenses. The focus lens 112 is driven by a focus lens driver 114.

The focus lens driver 114 includes, for example, an actuator or a motor, and moves the focus lens 112 along an optical axis of the optical system based on the control of the controller 135. The focus lens driver 114 can be implemented by a DC motor, a stepping motor, a servo motor, an ultrasonic motor, or the like.

The image sensor 120 captures the subject image formed via the optical system 110 to generate the image signal. The image sensor 120 generates image data of new frames, for example, at a predetermined frame rate (for example, 30 frames/second). The controller 135 controls a timing of generation of image signal by the image sensor 120 and an electronic shutter operation. As the image sensor 120, it is possible to use various image sensors such as a complementary metal-oxide semiconductor (CMOS) image sensor, a charge-coupled device (CCD) image sensor, and a negative-channel metal oxide semiconductor (NMOS) image sensor. The AFE 121 digitizes the image signal generated by the image sensor 120.

The hyperspectral filter 115 is disposed between the optical system 110 and the image sensor 120. The hyperspectral filter 115 disperses incident light into 20 or more wavelength bands (or wavelength regions). The hyperspectral filter 115 is an example of a spectroscopic element that disperses incident light into more than three plurality of wavelength bands. The hyperspectral filter 115 is, for example, a filter array including a plurality of optical filters two-dimensionally arranged in a direction perpendicular to the optical axis of the optical system 110. The hyperspectral filter is an example of the spectroscopic element or spectroscopic element of the present disclosure. The hyperspectral filter 115 will be described later in detail.

The image processor 130 performs various types of processing on the RAW image data to generate image data. Further, the image processor 130 performs various types of processing on image data read out from the memory card 142 to generate an image to be displayed on the display 160. Such an image is output to the image processing PC 200 via the communication interface 155. Examples of the various types of processing include white balance correction, gamma correction, YC conversion processing, electronic zoom processing, compression processing, and decompression processing, but the processing is not limited to these examples. The image processor 130 may be configured with a hard-wired electronic circuit, or may be configured with a processor, a microcomputer, or the like that uses a program.

The display 160 is a display device such as a liquid crystal display or an organic EL display capable of displaying information. For example, the display 160 displays an image based on the image data processed by the image processor 130. In addition, the display 160 displays a menu screen for the user to confirm settings of the hyperspectral camera 100.

The controller 135 integrally controls the entire operation of the hyperspectral camera 100. The controller 135 may include an electronic circuit configured to implement a predetermined function by executing a program. For example, the controller 135 can be implemented by various processors such as a CPU, an MPU, a GPU, a DSU, an FPGA, and an ASIC. The controller 135 may be configured with one or more processors. Furthermore, the controller 135 may be configured with a single semiconductor chip together with the image processor 130 and the like. Although not illustrated, the controller 135 includes a ROM. The ROM stores various programs such as a program for performing autofocus control (AF control) executed by the controller 135. In addition, the controller 135 incorporates a RAM (not illustrated) that functions as a work area for the CPU.

A buffer memory 125 is a recording medium functioning as a working memory for the image processor 130 and the controller 135. The buffer memory 125 is implemented by a dynamic random access memory (DRAM) or the like.

The memory card 142 is detachably inserted in the card slot 141. To the card slot 141, the memory card 142 can be electrically and mechanically connected. The memory card 142 is an external memory including therein a recording element such as a flash memory. The memory card 142 can store data such as the image data generated by the image processor 130.

The flash memory 145 is a nonvolatile recording medium capable of storing various types of data.

The operation member 150 is a general term for a user interface such as a hardware key or a software key of the hyperspectral camera 100, and accepts an operation by the user. The operation member 150 includes, for example, a button, a mode dial, a touch panel, and a switch. When receiving an operation by the user, the operation member 150 transmits to the controller 135 an operation signal corresponding to the user operation.

The communication interface 155 performs data communication in accordance with an existing wired communication standard or wireless communication standard. The communication interface 155 can be connected to a network such as an intranet or the Internet, and can receive information from an external device such as the image processing PC 200 and transmit information to the external device. Alternatively, the communication interface 155 may directly communicate with the external device not via the network. The communication interface 155 performs communication in accordance with, for example, a standard such as universal serial bus (USB), HDMI (registered trademark), or Bluetooth (registered trademark). The operation member 150 and the communication interface 155 are examples of an input interface of the present disclosure.

### 1-2. Image Processing PC

The image processing PC 200 includes a restoration processor 210, a storage 220, an input/output (I/O) interface 230, and a communication interface 240.

The restoration processor 210 performs restoration processing on the RAW image data received from the hyperspectral camera 100 to generate hyperspectral image data. The restoration processing will be described later in detail. Furthermore, the restoration processor 210 may include an electronic circuit that integrally controls the entire operation of the image processing PC 200 by executing a program. For example, the restoration processor 210 can be implemented by various processors such as a CPU, an MPU, a GPU, a DSU, an FPGA, and an ASIC. The restoration processor 210 may be configured with one or a plurality of processors.

The storage 220 is a recording medium that records various types of information including a program necessary for implementing a function of the image processing PC 200, a restoration table 221 to be described later, and the like. The storage 220 is implemented by, for example, a semiconductor storage device such as a flash memory or a solid state drive (SSD), a magnetic storage device such as a hard disk drive (HDD), or another recording medium alone or in combination of those devices. The storage 220 may include a memory such as an SRAM or a DRAM.

The input/output interface 230 is an example of an input interface that connects the image processing PC 200 and an input device in order to input, to the image processing PC 200, information from the input device such as a touch panel, a touch pad, a keyboard, a mouse, and a pointing device. For example, the input/output interface 230 receives an operation by the user via the input device. Furthermore, the input/output interface 230 is an example of an output unit that connects the image processing PC 200 and an output device such as a display, a sound output device, or a printer so that the image processing PC 200 can output a signal to the output device.

The communication interface 240 performs data communication in accordance with an existing wired communication standard or wireless communication standard. The communication interface 240 can be connected to a network such as an intranet or the Internet, and can receive information from an external device such as the hyperspectral camera 100 and transmit information to the external device.

Alternatively, the communication interface 240 may directly communicate with the external device not via the network. The communication interface 240 may have a configuration similar to that of the communication interface 155.

### 1-3. Principle of Obtaining Hyperspectral Image Data

### 1-3-1. Overview

As a principle by which the hyperspectral image data is obtained, the configuration and restoration processing of the hyperspectral filter 115 will be described below.

The hyperspectral image data is obtained using, for example, a known compressed sensing technique. The hyperspectral filter 115 transmits light incident on an incident surface from a subject, with different light transmission characteristics depending on regions. Specifically, for example, the hyperspectral filter 115 has a plurality of regions (hereinafter, also referred to as “cells”.) each corresponding to one of pixels of the image sensor 120, and each cell has its individual light transmission characteristic. The hyperspectral filter 115 is configured such that light transmission characteristics of the cells are arranged at random in a direction of the incident surface on which light from the subject is incident.

A process in which the hyperspectral filter 115 transmits light with different light transmission characteristics depending on the regions is also referred to as “encoding”, and the hyperspectral filter 115 may be referred to as “encoding mask”. The encoding makes it possible to extract, from the incident light, elements corresponding to more than three plurality of wavelength bands. The encoding is an example of “spectroscopy” of the present disclosure that separates incident light into more than three plurality of wavelength bands.

By imaging using the hyperspectral filter 115 as described above, compressed image data is obtained in which pieces of image information in a plurality of wavelength bands are compressed as one piece of two-dimensional image data. In the compressed image data, spectrum information of the subject is compressed and recorded as one pixel value for each pixel. In other words, each pixel included in the compressed image includes information corresponding to the plurality of wavelength bands. In this context, the image data of the subject or the above-described RAW image data acquired via the hyperspectral filter 115 may be referred to as “compressed image data”. In the compressed sensing technique, since information of a plurality of spectra is compressed, it is possible to reduce an amount of data processed by the image processor 130 and/or the restoration processor 210.

### 1-3-2. Configuration of Hyperspectral Filter

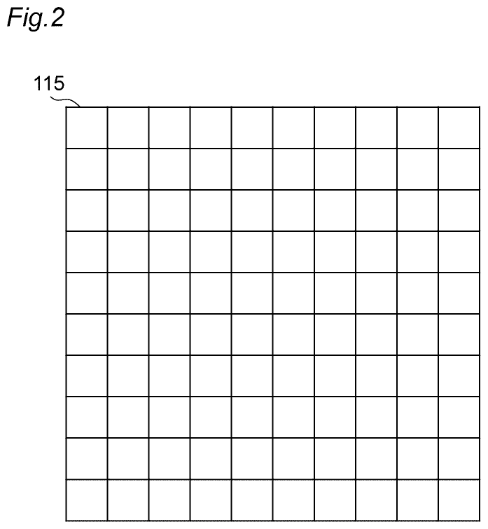

FIG. 2 is a schematic diagram illustrating an example of the configuration of the hyperspectral filter 115. FIG. 2 illustrates an example of a view of the hyperspectral filter 115 as viewed in an incident direction of the incident light. In the example illustrated in FIG. 2, the hyperspectral filter 115 has 100 cells arranged in 10×10. FIG. 2 is merely an example, and the number of cells of the hyperspectral filter 115 is not limited to 100. For example, the number of cells may be the same as the number of pixels of the image sensor 120 or may be less than 100.

The hyperspectral filter 115 can be configured with, for example, a mirror, a multilayer film, an organic material, a diffraction grating structure, or the like. Such a multilayer film includes, for example, a dielectric multilayer film or a metal layer. In this case, the multilayer film is formed such that at least one of the thickness and the material of the multilayer film is different for each cell. Thus, it is possible to allow each cell to have a different spectroscopic characteristic.

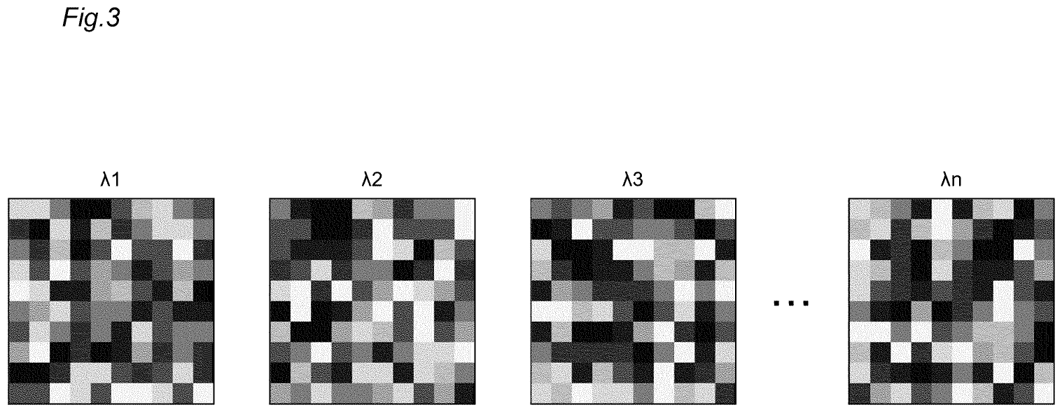

FIG. 3 is a diagram illustrating an example of transmittance, of the hyperspectral filter 115, for light in each of a plurality of wavelength bands λ1, λ2, . . . ,λn (n is an integer more than three) included in incident light that is incident on the hyperspectral filter 115. In the example of FIG. 3, a density difference in blacks or whites on each cell represents a difference in transmittance. A lighter black region has higher transmittance, and a darker black region has lower transmittance. As illustrated in FIG. 3, a spatial distribution of light transmittance is different for each wavelength band.

In the hyperspectral filter 115, transmission spectra of at least two of the plurality of cells (filters) are different from each other. That is, the hyperspectral filter 115 includes a plurality of filters having mutually different transmission spectra. In one example, the number of patterns of transmission spectra of the plurality of filters included in the hyperspectral filter 115 is the number of wavelength bands included in the incident light or more. The hyperspectral filter 115 may be configured such that the transmission spectra of half or more of the filters are different from each other.

Data indicating such a spatial distribution of the transmittance of the hyperspectral filter 115 is acquired in advance based on design data, simulation data, or actual measurement data, and is used to create the restoration table 221. The restoration table 221 is stored in the storage 220 of the image processing PC 200.

### 1-3-3. Restoration Processing

The restoration processor 210 of the image processing PC 200 performs the restoration processing based on the compressed image data received from the hyperspectral camera 100 and the restoration table 221. The restoration table 221 may be, for example, data indicating a spatial distribution of optical response characteristics of the encoding mask. By the restoration processing based on the restoration table 221, it is possible to generate, from one piece of compressed image data, restored image data (hyperspectral image data) including a plurality of pieces of image information each corresponding to one of the plurality of wavelength bands.

The hyperspectral image data generated in this manner includes, for example: a piece of image information for the wavelength band λ1, a piece of image information for the wavelength band λ2, . . . , and a piece of image information for the wavelength band λn.

In the restoration processing, the restoration processor 210 may derive the pixel values of all the pixels based on the compressed image data and the restoration table 221.

Instead of or in addition to deriving the pixel values of all the pixels, it is also possible to perform the following processing, which estimates at least some pixel values. That is, in a general image, adjacent pixels often have colors or pixel values that are close to each other to some extent. Similarly, the following knowledge is obtained. In an image indicated by the pieces of image information corresponding to respective one of the wavelength bands of the hyperspectral image data, adjacent pixels are smoothly connected to each other to some extent in terms of color or pixel value. Based on such knowledge, the restoration processor 210 may estimate, in the restoration processing, the restored image data such that adjacent pixels are smoothly connected in terms of color or pixel value. As a result, it is possible to reduce a processing load on the restoration processor 210 while maintaining restoration accuracy.

### 2. Operation

As described above, the hyperspectral image data includes a plurality of pieces of image information each corresponding to one of a plurality of wavelength bands. By paying attention to an image corresponding to a specific wavelength band of the hyperspectral image data, it may be possible to detect a color, a contrast, and the like that are difficult to detect in an RGB image and with a naked eye. This may lead, for example, to a discovery of a defect in a product that is difficult to see in an RGB image and with a naked eye.

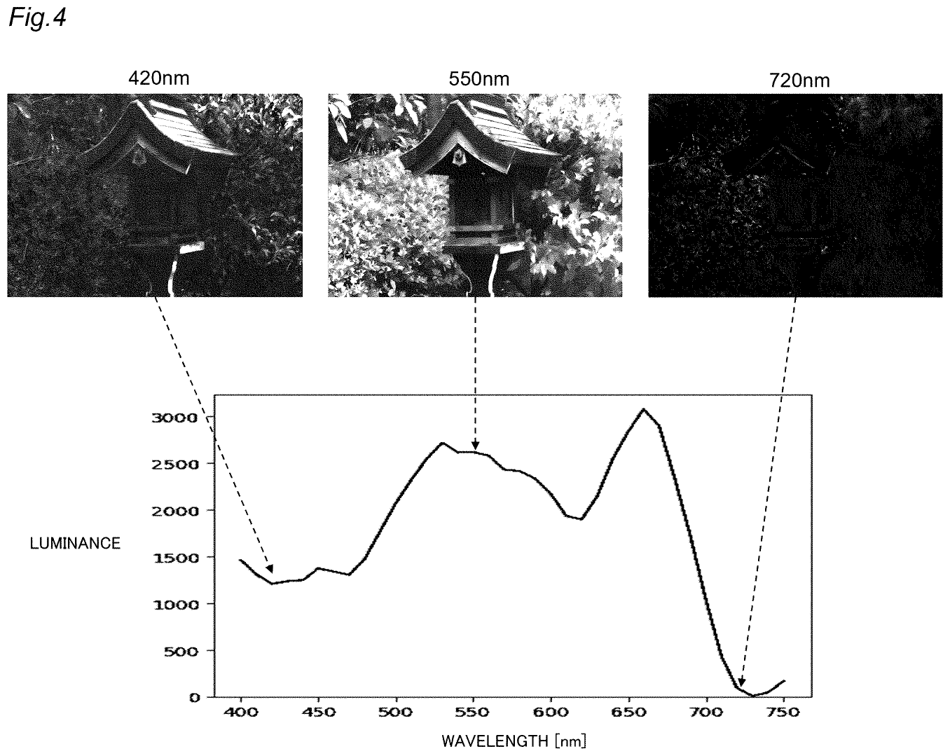

However, as illustrated in FIG. 4, the luminance of each of the plurality of pieces of image information included in the hyperspectral image data may vary depending on the wavelength band. Therefore, in a case where a conventional auto exposure (AE) processing, which controls the exposure based on a luminance of a captured image without paying attention to a specific wavelength band, is performed, appropriate exposure may not be achieved for a specific wavelength band to which the user desires to pay attention. In such a case, the number of signals related to the specific wavelength band is too small or too large, so that an image cannot be obtained with desired accuracy. In the example of FIG. 4, the exposure for the image corresponding to a 550 nm band is appropriate; however, when paying attention to the image corresponding to a 770 nm band, the exposure is too low, and the luminance is accordingly smaller (darker).

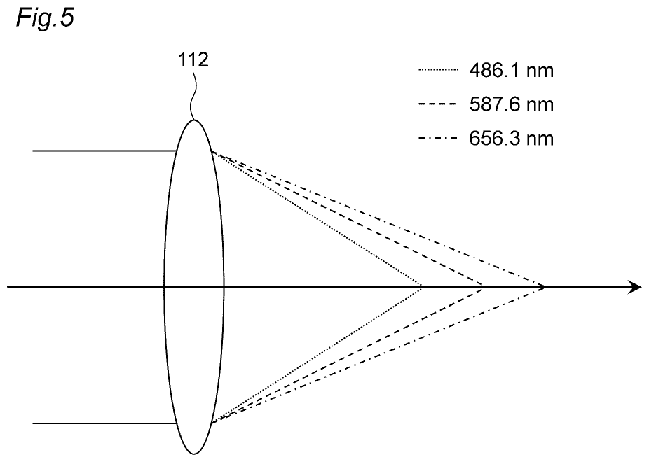

Furthermore, as illustrated in FIG. 5, a focus position of the focus lens 112 varies depending on a wavelength of the incident light. Therefore, in a case where conventional AF processing, which controls the focus position of the focus lens 112 based on the captured image without paying attention to a specific wavelength band, is performed, an image corresponding to a specific wavelength band to which the user desires to pay attention may not be in focus.

The present embodiment provides the imaging system 1 in which it possible to achieve appropriate exposure with respect to the light of the first wavelength band by performing the AE processing based on a luminance value of a piece of image information corresponding to a first wavelength band selected by the user. Furthermore, the imaging system 1 according to the present embodiment can perform the AF processing based on the image indicated by a piece of image information corresponding to a second wavelength band selected by the user. The second wavelength band may be the same as or different from the first wavelength band.

Hereinafter, an operation of the imaging system 1 according to the present embodiment will be described in more detail.

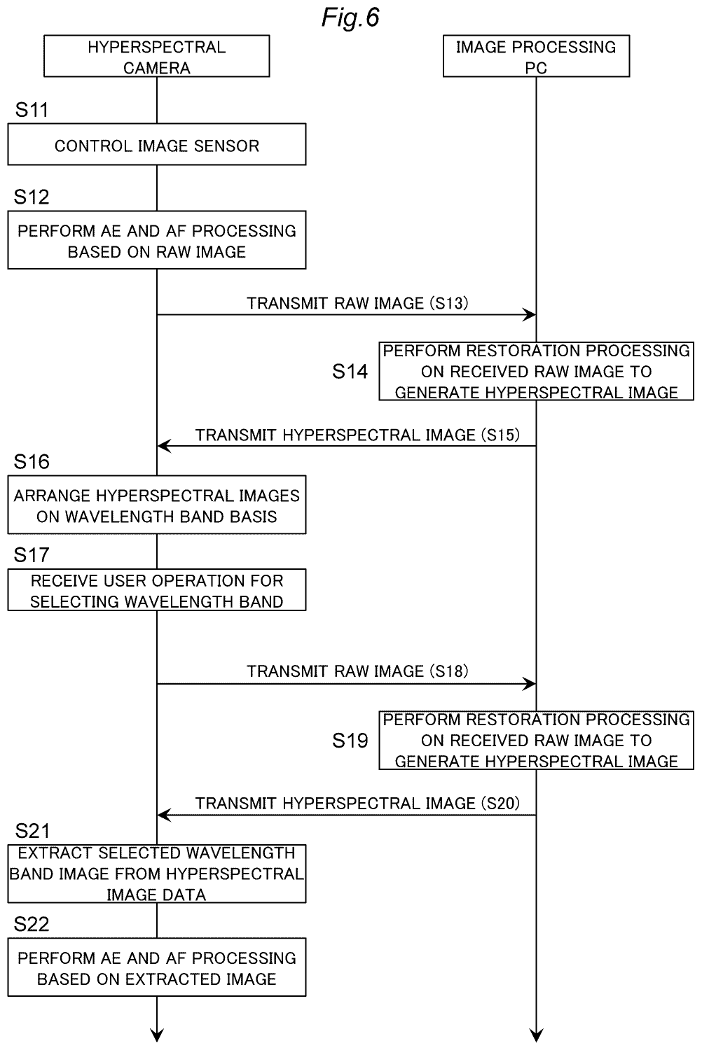

FIG. 6 is a sequence diagram for describing the operation of the imaging system 1 according to the present embodiment. The operation of FIG. 6 is executed by the controller 135 of the hyperspectral camera 100 and the restoration processor 210 of the image processing PC 200. The hyperspectral camera 100 starts to operate when the hyperspectral camera 100 is powered on, for example.

In FIG. 6, first, the hyperspectral camera 100 controls the image sensor 120 based on a user operation received by the operation member 150 such as a shutter button (S11). In accordance with the control of the hyperspectral camera 100, the image sensor 120 captures a subject image formed via the optical system 110 and the hyperspectral filter 115, generates an image signal, and transmits the image signal to the AFE 121. The AFE 121 digitizes the image signal received from the image sensor 120. The AFE 121 outputs the original image data (RAW image data) indicated by the digitized image signal to the image processor 130. Such RAW image data generation is repeatedly performed, for example, at a predetermined frame rate.

Next, the hyperspectral camera 100 performs the AE processing and the AF processing based on a RAW image indicated by the RAW image data (S12). In the AE processing, the hyperspectral camera 100 performs exposure control by controlling a shutter speed, an aperture value, an ISO sensitivity, and the like based on, for example, a luminance value of the RAW image. In the AF processing, the hyperspectral camera 100 controls the focus position of the focus lens 112, for example, by moving the focus lens 112 via the focus lens driver 114 so as to maximize a contrast value of the RAW image.

The hyperspectral camera 100 transmits, to the image processing PC 200, the RAW image data obtained by an imaging operation after step S12, that is, an imaging operation to which the AE processing and the AF processing are applied (S13).

The image processing PC 200 performs the restoration processing on the received RAW image data using the restoration table 221 thereby to generate hyperspectral image data (S14), and transmits the generated hyperspectral image data to the hyperspectral camera 100 (S15).

The hyperspectral camera 100 displays, on the display 160, images (hereinafter, the images are referred to as “wavelength band images”) indicated by the pieces of image information corresponding to respective ones of the wavelength bands included in the received hyperspectral image data such that the images are arranged on a wavelength band basis (S16).

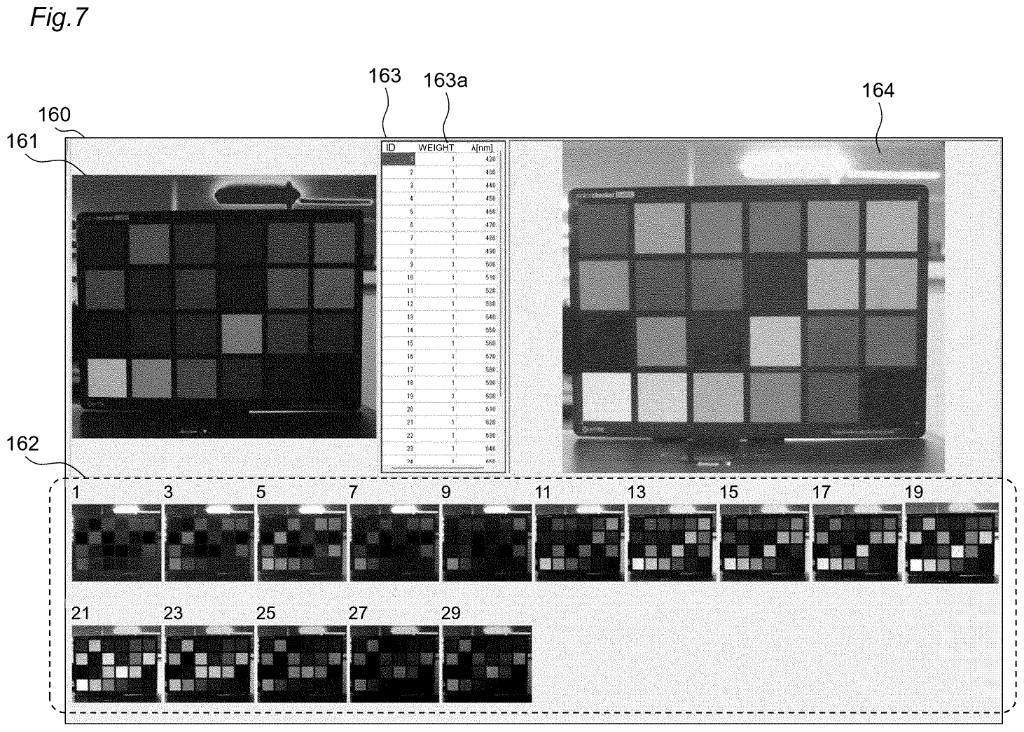

FIG. 7 is a diagram illustrating an example of a display screen displayed on the display 160 in step S16. A live view image 161 for live view is displayed on the display screen of FIG. 7. The live view is a function to display an image captured by the hyperspectral camera 100 as a real-time moving image or the like. As the live view image 161, a RAW image is displayed, for example.

The display screen of FIG. 7 includes a hyperspectral image display area 162 in which the wavelength band images each corresponding to one of the wavelength bands are displayed. In the hyperspectral image display area 162 illustrated in FIG. 7, there are displayed fifteen wavelength band images corresponding to respective ones of the fifteen wavelength bands. A wavelength band ID indicating its corresponding wavelength band is provided upper left of the corresponding wavelength band image in the hyperspectral image display area 162. The wavelengths indicated by the wavelength band IDs are shown in a wavelength band table 163a displayed in a band display area 163.

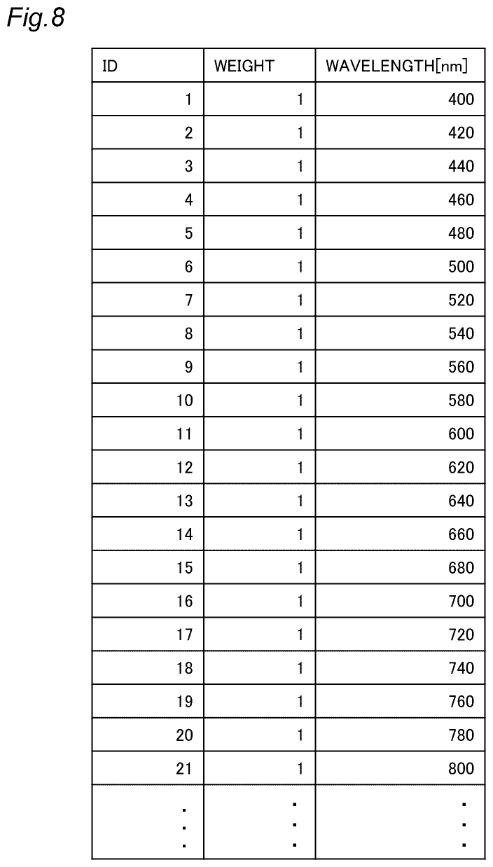

FIG. 8 is an enlarged view of the wavelength band table 163a illustrated in FIG. 7. An “ID” column of the wavelength band table 163a shows the wavelength band IDs, and the wavelengths corresponding to the wavelength band IDs are shown in a “wavelength” column. A “weight” column shows weight coefficients for the images in the wavelength bands corresponding to the wavelength band IDs, the weight coefficients being used when images are combined. In the example of FIGS. 7 and 8, an image indicated by a piece of image information corresponding to the wavelength band of 400 nm corresponds to the wavelength band ID “1”, and an image indicated by a piece of image information corresponding to the wavelength band of 420 nm corresponds to the wavelength band ID “2”. The wavelength band ID “3” and the subsequent wavelength bands are also illustrated in FIG. 8.

With reference again to FIG. 7, it is not necessary to display the images corresponding to all the wavelength band IDs of the wavelength band table 163a in the hyperspectral image display area 162. For example, only images corresponding to preset wavelength band IDs may be displayed in the hyperspectral image display area 162. In the example of FIG. 7, only images indicated by pieces of image information corresponding to wavelength bands whose wavelength band IDs are odd numbers are illustrated.

Furthermore, on the display screen of FIG. 7, there is displayed a composite image 164 obtained by combining the images indicated by the pieces of image information corresponding to respective ones of the wavelength bands of the hyperspectral image data. The composite image 164 is, for example, an RGB image.

The live view image 161, the wavelength band images, and the composite image 164 in FIG. 7 may be still images or may be updated at predetermined time intervals. In the case where the images are updated, a speed of the update may be the same as the frame rate (for example, 30 frames/sec) at which the image data is generated by the image sensor 120 described above. Alternatively, in order to reduce a processing load, these images may be updated at time intervals longer than the intervals at which the frames are generated by the image sensor 120, for example, at time intervals of about once every several seconds. The update intervals of the images of the live view image 161, the wavelength band images, and the composite image 164 may be the same or different from each other.

With reference again to FIG. 6, the hyperspectral camera 100 receives a user operation for selecting a wavelength band (S17). For example, the user selects the wavelength band to be subjected to the AE processing and/or the AF processing while viewing the hyperspectral image display area 162 and the band display area 163 on the display screen of FIG. 7. The user operation for selecting the wavelength band will be described later in detail.

The image processing PC 200 generates the hyperspectral image data at a predetermined frame rate. Therefore, also after step S17, the hyperspectral camera 100 transmits the RAW image data to the image processing PC 200 (S18), and the image processing PC 200 performs the restoration processing on the RAW image data thereby to generate the hyperspectral image data (S19). The image processing PC 200 transmits the generated hyperspectral image data to the hyperspectral camera 100 (S20).

The hyperspectral camera 100 extracts, from the received hyperspectral image data, a wavelength band image corresponding to the wavelength band selected in step S17 (S21).

Next, the hyperspectral camera 100 performs the AE processing and the AF processing based on the wavelength band image extracted in step S21 (S22).

In the AE processing, the hyperspectral camera 100 performs the exposure control by controlling the shutter speed, the aperture value, the ISO sensitivity, and the like based on, for example, a luminance value of the wavelength band image extracted in step S21.

In the AF processing, the hyperspectral camera 100 adjusts a position of the focus lens 112 along the optical axis of the optical system 110 in accordance with an evaluation value regarding a focus state of the wavelength band image extracted in step S21, for example, via the focus lens driver 114.

An example of the evaluation value is a contrast value regarding the wavelength band image for each position of the focus lens 112. For example, the controller 135 of the hyperspectral camera 100 controls the focus position of the focus lens 112 by moving the focus lens 112 such that the contrast value of the extracted wavelength band image is maximized. The controller 135 may calculate the evaluation value by at least one of an image plane phase difference method, a phase difference method, and a depth from defocus (DFD) method.

### 3. User Interface for Implementation of Operation

### 3-1. Selection of Wavelength Region for AE

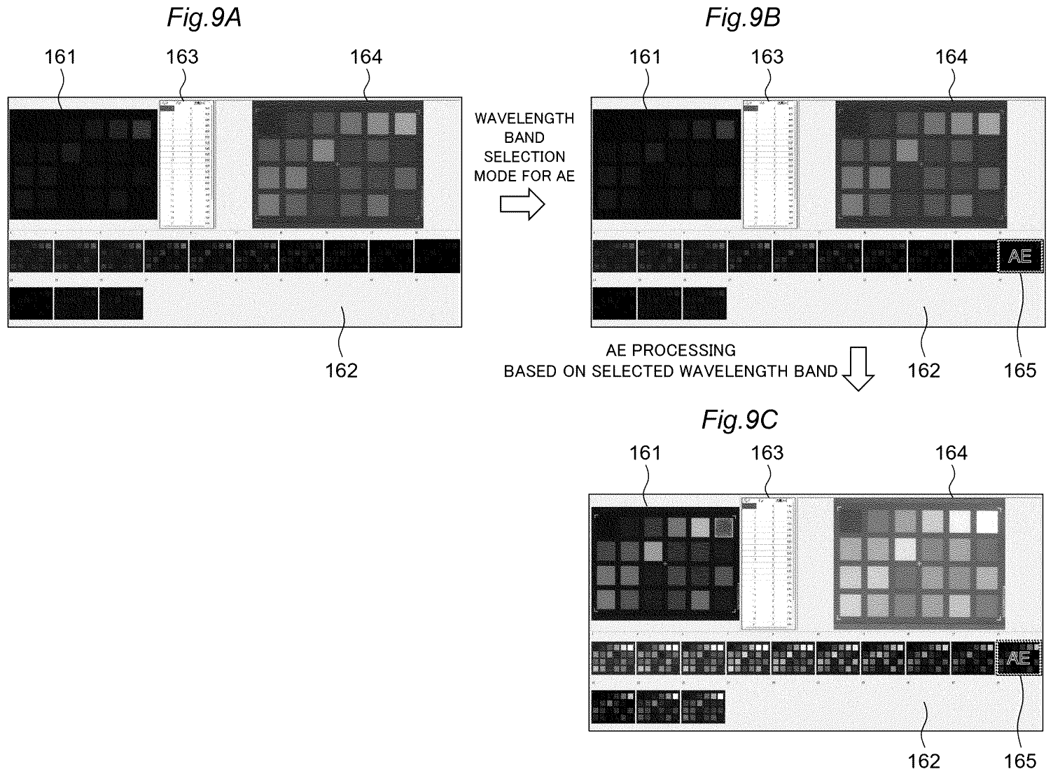

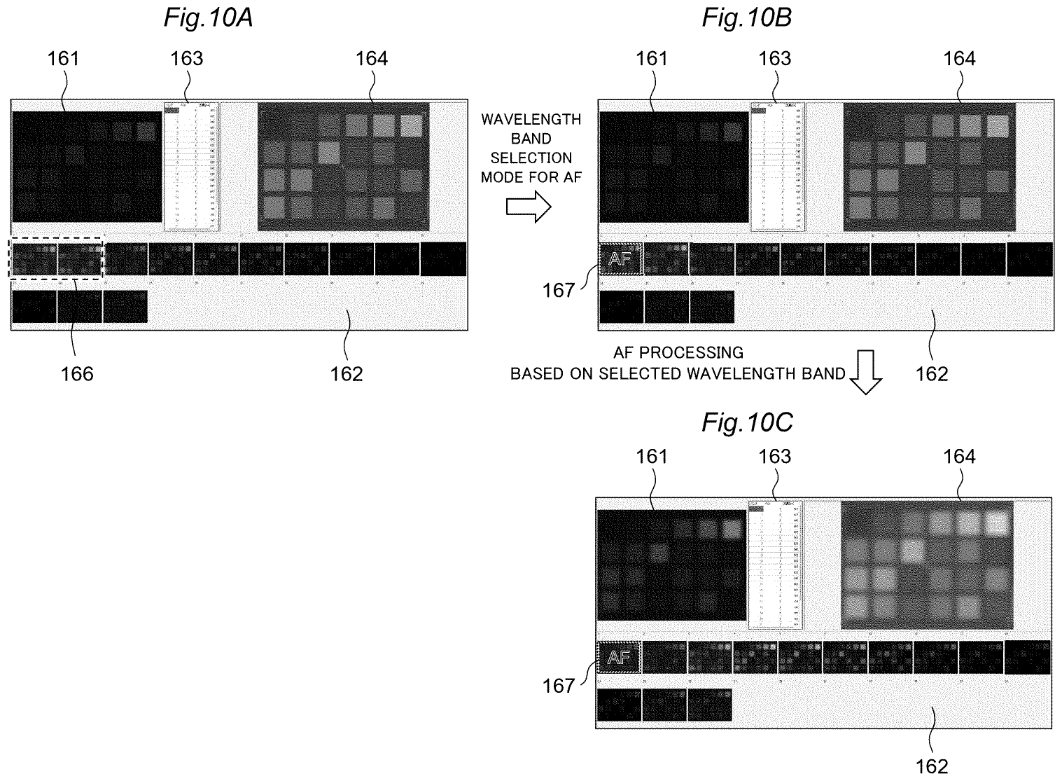

FIGS. 9A to 9C and FIGS. 10A to 10C are diagrams for describing a series of processing in steps S17 to S22 in FIG. 6. FIGS. 9A to 9C and FIGS. 10A to 10C each illustrate a display screen displayed on the display 160. Hereinafter, the AE processing and the AF processing based on the wavelength band image corresponding to the wavelength band selected by the user operation will be described with reference to FIGS. 9A to 9C and FIGS. 10A to 10C.

The display screen of FIG. 9A illustrates a state similar to that of the display screen of FIG. 7. Results of the AE processing and the AF processing based on the RAW image are reflected in the live view image 161, the wavelength band images displayed in the hyperspectral image display area 162, and the composite image 164.

Depending on what the hyperspectral image data is used for, a wavelength band to which the user desires to pay attention may vary. In a case where a conventional AE processing, which controls the exposure based on a luminance of a captured image without paying attention to a specific wavelength band, is performed, appropriate exposure may not be achieved for a specific wavelength band to which the user desires to pay attention. In the example illustrated in FIGS. 9A to 9C, when the user desires to adjust the exposure for a wavelength band image corresponding to a specific wavelength band, the user can select the wavelength band to which the user desires to pay attention by using the operation member 150 to shift to a wavelength band selection mode for AE.

When the user selects, on the display screen of FIG. 9A by using the operation member 150, the wavelength band selection mode for AE, the controller 135 of the hyperspectral camera 100 changes the displayed screen to a wavelength band selection screen illustrated in FIG. 9B.

On the wavelength band selection screen of FIG. 9B, the user can select, by using the operation member 150, one wavelength band image corresponding to the first wavelength band from the plurality of wavelength band images displayed in the hyperspectral image display area 162. In the example illustrated in FIG. 9B, the user can select the wavelength band image by moving, in the hyperspectral image display area 162, an icon 165 indicating a text “AE”. Alternatively, or in addition, the user may select the wavelength band to which the user desires to pay attention from the wavelength band table 163a displayed in the band display area 163.

Upon receiving the user operation for selecting the wavelength band (S17 in FIG. 6), the controller 135 extracts the wavelength band image corresponding to the selected wavelength band from the hyperspectral image data (S21), and performs the AE processing based on the extracted wavelength band image (S22). In this manner, by performing the AE processing based on a luminance value of the piece of image information corresponding to the specific wavelength band selected by the user operation, it is possible to achieve appropriate exposure for the specific wavelength band.

The controller 135 causes the display 160 to display a display screen of FIG. 9C that displays the live view image 161 reflecting a result of the AE processing based on the extracted wavelength band image, the wavelength band images in the hyperspectral image display area 162, and the composite image 164.

By viewing the image displayed on the display screen of FIG. 9C, particularly by viewing the wavelength band image corresponding to the selected wavelength band in the hyperspectral image display area 162, the user can check whether appropriate exposure has been achieved for the wavelength band to which the user pays attention.

### 3-2. Selection of Wavelength Region for AF

The display screen of FIG. 10A illustrates a state similar to the display screen of FIG. 7 and the display screen of FIG. 9A.

In the composite image 164 in FIG. 10A, even when an object seems to be in focus, the object may be blurred in the wavelength band image corresponding to the wavelength band to which the user desires to pay attention. In the example illustrated in FIG. 10A, in particular, wavelength band images 166 corresponding to short wavelength bands (for example, 400 nm band, 420 nm band) are blurred. When the user desires to cause the wavelength band image corresponding to a short wavelength band to be in focus, the user can select a wavelength band to which the user desires to pay attention, by using the operation member 150 to shift to a wavelength band selection mode for AF.

When the user selects, on the display screen of FIG. 10A by using the operation member 150, the wavelength band selection mode for AF, the controller 135 of the hyperspectral camera 100 changes the displayed screen to a wavelength band selection screen illustrated in FIG. 10B. On the wavelength band selection screen of FIG. 10B, the user can select, by using the operation member 150, one wavelength band image corresponding to the second wavelength band from the plurality of wavelength band images displayed in the hyperspectral image display area 162. In the example illustrated in FIG. 10B, the user can select a wavelength band image by moving, in the hyperspectral image display area 162, an icon 167 indicating a text “AF”. Alternatively, or in addition, the user may select the wavelength band to which the user desires to pay attention from the wavelength band table 163a displayed in the band display area 163.

Upon receiving the user operation for selecting the wavelength band (S17 in FIG. 6), the controller 135 extracts the wavelength band image corresponding to the selected wavelength band from the hyperspectral image data (S21), and performs the AF processing based on the extracted wavelength band image (S22). As described above, by performing the AF processing based on the luminance value of the piece of image information corresponding to the specific wavelength band selected by the user operation, it is possible to adjust the focus position of the focus lens 112 such that the object is in focus in the wavelength band image corresponding to the specific wavelength band.

### 4. Advantageous Effects and the Like

### 4-1. Advantageous Effects and the Like Regarding Exposure Adjustment

As described above, the hyperspectral camera 100, which is an example of the imaging device according to the present embodiment, includes: the hyperspectral filter 115, which is an example of the spectroscopic element; the image sensor 120; the operation member 150, which is an example of the input interface; and the controller 135, which is an example of the control unit. The hyperspectral filter 115 disperses incident light into more than three plurality of wavelength bands. The image sensor 120 captures a subject image via the hyperspectral filter 115 to generate image data. The operation member 150 receives first selection information indicating a first wavelength band selected by a user from a plurality of wavelength bands. The controller 135 adjusts exposure based on a luminance value of a piece of image information corresponding to the first wavelength band included in the hyperspectral image data (an example of the multispectral image data) including pieces of image information each corresponding to one of the plurality of wavelength bands (S22).

According to the hyperspectral camera 100 according to the present embodiment, it is possible to achieve appropriate exposure for an image desired by the user, in an image containing more than three plurality of wavelength bands.

The hyperspectral image data may be generated based on the image data, and the controller 135 may obtain the hyperspectral image data and adjust exposure based on a luminance value included in the hyperspectral image data. With this configuration, it is possible to achieve appropriate exposure for an image desired by the user based on the acquired hyperspectral image data.

The hyperspectral filter 115 may be a filter array including a plurality of filters having mutually different transmission spectra. The hyperspectral image data is generated based on the image data and the restoration table 221 determined based on the spatial distribution of the transmission spectra of the plurality of filters. This configuration makes it possible to obtain the hyperspectral image data in one shot without scanning a subject. For example, this configuration is advantageous in a case where the subject moves irregularly or in a case where it is desired to obtain a hyperspectral moving image.

The hyperspectral camera 100 according to the present embodiment may further include the display 160 that is an example of a display unit that displays a plurality of images each indicated by one of the pieces of image information. With this configuration, the user can know, by viewing the display 160, the pieces of image information corresponding to the plurality of wavelength bands included in the hyperspectral image data.

The operation member 150 may receive the first selection information indicating the first wavelength band selected by the user, by receiving a user operation of selecting one or a plurality of images from the images displayed on the display 160. This configuration enables the user to select the specific wavelength band from the plurality of wavelength bands while checking a luminance of each of the images displayed on the display 160.

In the hyperspectral camera 100 according to the present embodiment, light may be incident on the spectroscopic element via the optical system, and the operation member 150 may receive a second selection information indicating a second wavelength band selected by the user from the plurality of wavelength bands. The controller 135 may control a focus position of the optical system based on a piece of image information that is included in the multispectral image data and corresponds to the second wavelength band. According to this configuration, it is possible to appropriately control the focus position of the optical system with respect to light in the second wavelength band selected by the user.

### 4-2. Advantageous Effects and the Like Regarding Control of In-Focus Position of Optical System

The hyperspectral camera 100, which is an example of the imaging device according to the present embodiment, includes: the image sensor 120; the hyperspectral filter 115, which is an example of the spectroscopic element; the operation member 150, which is an example of the input interface, and the controller 135, which is an example of the controller. The image sensor 120 captures a subject image formed via the optical system 110 to generate image data. The hyperspectral filter 115 is disposed between the optical system 110 and the image sensor 120, and disperses incident light into more than three plurality of wavelength bands. The operation member 150 receives selection information indicating a specific wavelength band selected by the user from a plurality of wavelength bands. The controller 135 controls a focus position of the optical system 110 based on a piece of image information corresponding to the specific wavelength band included in hyperspectral image data (an example of the multispectral image data) including pieces of image information each corresponding to one of the plurality of wavelength bands (S22).

With the hyperspectral camera 100 according to the present embodiment, it is possible to appropriately control the focus position of the optical system with respect to light in the specific wavelength band selected by the user.

The hyperspectral image data may be generated based on the image data, and the controller 135 may obtain the hyperspectral image data and adjust the focus position of the optical system based on a piece of image information corresponding to the specific wavelength band included in the hyperspectral image data. With this configuration, it is possible to appropriately control the focus position of the optical system based on the acquired hyperspectral image data.

The hyperspectral filter 115 may be a filter array including a plurality of filters having mutually different transmission spectra. The hyperspectral image data is generated based on the image data and the restoration table 221 determined based on the spatial distribution of the transmission spectra of the plurality of filters. This configuration makes it possible to obtain the hyperspectral image data in one shot without scanning a subject. For example, this configuration is advantageous in a case where the subject moves irregularly or in a case where it is desired to obtain a hyperspectral moving image.

The hyperspectral camera 100 according to the present embodiment may further include the display 160 that is an example of a display unit that displays a plurality of images each indicated by one of the pieces of image information. With this configuration, the user can know, by viewing the display 160, the pieces of image information corresponding to the plurality of wavelength bands included in the hyperspectral image data.

The operation member 150 may receive selection information indicating a specific wavelength band selected by the user, by receiving a user operation of selecting one or a plurality of images from the images displayed on the display 160. This configuration enables the user to select the specific wavelength band from the plurality of wavelength bands while checking a luminance of each of the images displayed on the display 160.

### Other Embodiments

The embodiment has been described in the above as an example of the techniques in the present disclosure. However, the techniques of the present disclosure can be applied not only to the above embodiments but also to an embodiment in which modification, replacement, addition, or removal is appropriately made. Furthermore, it is possible to form a new embodiment by combining the components described in the above embodiment. Therefore, modifications as other embodiments will be exemplified below.

### First Modification

The above embodiment has described an example in which the image processing PC 200 performs the processing of generating the hyperspectral image by performing the restoration processing on the RAW image, but an execution body of the restoration processing is not limited to the image processing PC 200. For example, the hyperspectral camera may perform the restoration processing.

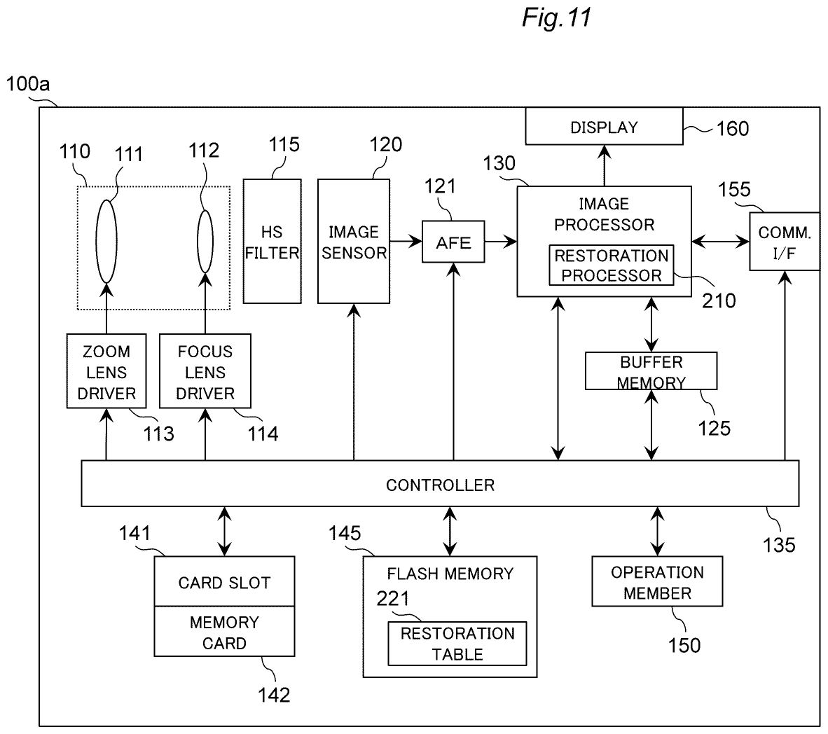

FIG. 11 is a block diagram illustrating a configuration example of a hyperspectral camera 100a according to a first modification. Unlike the hyperspectral camera 100 in FIG. 1, in the hyperspectral camera 100a, the restoration processor 210 is included in the image processor 130 which is an example of a processing circuit. In addition, the flash memory 145 stores the restoration table 221.

With the present modification, the hyperspectral camera 100a can perform exposure adjustment and/or control of the focus position of the optical system according to the present disclosure without need for an external device such as the image processing PC 200.

### Second Modification

The above embodiment has described an example in which the hyperspectral camera 100 displays a plurality of wavelength band images in the hyperspectral image display area 162 of the display screen displayed on the display 160 (S16 in FIG. 6) and receives a user operation for selecting a wavelength band (S17). However, the present disclosure is not limited thereto, and the image processing PC 200 may receive a user operation for selecting the wavelength band.

For example, the image processing PC 200 may display a display screen as illustrated in FIG. 7 and FIGS. 9A to 9C on a display device such as an external display connected to the input/output interface 230 and receive a user operation performed by the user in accordance with the display screen. For example, the image processing PC 200 receives the user operation for selecting the wavelength band via an input device such as a touch panel, a touch pad, a keyboard, a mouse, or a pointing device connected to the input/output interface 230.

Upon receiving the user operation for selecting the wavelength band, the image processing PC 200 transmits selection information indicating a selected specific wavelength band to the hyperspectral camera 100. The communication interface 155, which is an example of an input interface of the hyperspectral camera 100, receives the selection information transmitted by the image processing PC 200.

As in the present modification, by using an external display and an input device connected to the image processing PC 200 instead of by using the display 160 and the operation member 150 of the hyperspectral camera 100 of the first embodiment, it is possible to improve operability of a user operation for selecting a wavelength band.

### Third Modification

The second modification has described an example in which, upon receiving the user operation of selecting the wavelength band, the image processing PC 200 transmits, to the hyperspectral camera 100, the selection information indicating the selected specific wavelength band. In a third modification, instead of transmitting the selection information indicating the selected specific wavelength band to the hyperspectral camera 100 as in the second modification, the image processing PC 200 may perform an operation related to at least one of the following AE processing and AF processing.

As an operation related to the AE processing, when receiving a user operation for selecting a wavelength band, the image processing PC 200 may calculate setting values related to exposure such as a shutter speed, an aperture value, and an ISO sensitivity based on a luminance value of a wavelength band image corresponding to the selected wavelength band. The image processing PC 200 transmits the calculated setting values to the hyperspectral camera 100, and the hyperspectral camera 100 adjusts the exposure by controlling the shutter speed, the aperture value, the ISO sensitivity, and the like according to the received setting values.

As an operation related to the AF processing, when receiving a user operation for selecting a wavelength band, the image processing PC 200 may calculate a setting value indicating a target position of the focus lens 112 based on an evaluation value related to a focusing state of a wavelength band image corresponding to the selected wavelength band. The image processing PC 200 transmits the calculated setting value to the hyperspectral camera 100, and the hyperspectral camera 100 adjusts the position of the focus lens 112 according to the received setting value.

Since the image processing PC 200 performs the calculation of the setting value or setting values related to at least one of the AE processing and the AF processing, it is possible to reduce a processing load of the hyperspectral camera 100 related to the calculation.

### Fourth Modification

The above embodiment has described the hyperspectral camera 100 that includes the hyperspectral filter 115, which is an example of the spectroscopic element and handles the hyperspectral image data, and has described the image processing PC 200. The hyperspectral camera 100 includes a camera capable of acquiring information regarding 20 or more wavelength bands, for example, regarding 100 or more wavelength bands.

However, the spectroscopic element of the present disclosure only needs to have a configuration in which incident light is dispersed into more than three plurality of wavelength bands, and is not limited to the hyperspectral filter 115. For example, the spectroscopic element of the present disclosure may be a multispectral filter that disperses incident light into more than three plurality of wavelength bands. Therefore, the imaging device according to the present disclosure is not limited to the hyperspectral camera 100, and may be a multispectral camera. The imaging device and/or the image processing PC 200 according to the present disclosure may handle multispectral image data instead of the hyperspectral image data.

The multispectral camera only needs to be able to acquire information regarding more than three plurality of wavelength bands, and may be configured to be able to acquire, for example, information regarding wavelength bands of about 10, or may be configured to be able to acquire information regarding wavelength bands of 20 or more, for example, regarding wavelength bands of 100 or more.

### Fifth Modification

In the above embodiment, the hyperspectral filter 115 has been described as an example of the spectroscopic element, but the spectroscopic element is not limited to the hyperspectral filter 115 as long as it is possible to extract elements corresponding to more than three plurality of wavelength bands from incident light. For example, the spectroscopic element may be an optical element that includes a prism or a grating and disperses incident light into more than three plurality of wavelength bands. In a case where the hyperspectral filter 115 is used, the hyperspectral image data is obtained by a known snapshot-type operation; however, in a case where an optical element such as a prism or a grating is used, a scan-type operation is adopted, for example.

For example, in the case of using a prism, when light from a subject passes through the prism, the light is emitted from an emission surface of the prism at emission angles corresponding to wavelengths. In the case of using a grating, when light from a subject enters the grating, the light is diffracted at diffraction angles corresponding to wavelengths. The hyperspectral image data can be obtained by separating light from a subject into wavelength bands using a prism or a grating and detecting the separated light for each wavelength band.

### Sixth Modification

The above embodiment has exemplified the hyperspectral camera 100 including the optical system 110, the zoom lens driver 113, and the focus lens driver 114. The imaging device of the present disclosure does not need to include the optical system 110, the zoom lens driver 113, or the focus lens driver 114, and may be, for example, an interchangeable lens type hyperspectral camera. In this case, the optical system 110, the zoom lens driver 113, and the focus lens driver 114 are provided in an interchangeable lens.

### Seventh Modification

In the above embodiment, a hyperspectral camera is described as an example of the imaging device, but the imaging device is not limited to the digital camera. The imaging device of the present disclosure may be electronic equipment having a hyperspectral imaging function (for example, a video camera, a smartphone, a tablet terminal, or the like).

### Example of Aspects

Hereinafter, various aspects according to the present disclosure will be listed.

Aspect 1 provides an imaging device including:
a spectroscopic element that disperses incident light into more than three plurality of wavelength bands;
an image sensor that captures a subject image via the spectroscopic element to generate image data;
an input interface that receives first selection information indicating a first wavelength band selected by a user from the plurality of wavelength bands; and
a controller that adjusts exposure based on a luminance value of a piece of image information that is included in multispectral image data and corresponds to the first wavelength band, the multispectral image data including pieces of image information corresponding to the plurality of wavelength bands, respectively.

Aspect 2 provides the imaging device according to aspect 1, wherein the multispectral image data is generated based on the image data, and the controller acquires the multispectral image data and adjusts the exposure based on the luminance value included in the multispectral image data.

Aspect 3 provides the imaging device according to aspect 2, further including a processing circuit that generates the multispectral image data based on the image data.

Aspect 4 provides the imaging device according to any of the preceding aspects, wherein
the spectroscopic element is a filter array including a plurality of filters with different transmission spectra from each other, and
the multispectral image data is generated based on the image data and a restoration table determined based on a spatial distribution of the transmission spectra of the plurality of filters.

Aspect 5 provides the imaging device according to any of the preceding aspects, further including a display that displays a plurality of images indicated by the pieces of image information, respectively.

Aspect 6 provides the imaging device according to aspect 5, wherein, by receiving a user operation of selecting one or a plurality of images from the images displayed on the display, the input interface receives the first selection information indicating the first wavelength band selected by the user.

Aspect 7 provides the imaging device according to any of the preceding aspects, wherein
the light is incident on the spectroscopic element via an optical system,
the input interface receives second selection information indicating a second wavelength band selected by the user from the plurality of wavelength bands, and
the controller controls a focus position of the optical system based on the piece of image information that is included in the multispectral image data and corresponds to the second wavelength band.

Aspect 8 provides an imaging method including:
generating image data by capturing a subject image via a spectroscopic element that disperses incident light into more than three plurality of wavelength bands;
receiving selection information indicating a first wavelength band selected by a user from the plurality of wavelength bands; and
adjusting exposure based on a luminance value of a piece of image information that is included in multispectral image data and corresponds to the first wavelength band, the multispectral image data including pieces of image information corresponding to the plurality of wavelength bands, respectively.

Aspect 9 provides an imaging system including:
an imaging device; and
an image processing device communicably connected to the imaging device,
the imaging device including:
   a spectroscopic element that disperses incident light into more than three plurality of wavelength bands;
   an image sensor that captures a subject image via the spectroscopic element to generate image data;
   a communication interface that sends the image data to the image processing device;
   an input interface that receives first selection information indicating a first wavelength band selected by a user from the plurality of wavelength bands; and
   a controller that adjusts exposure,
wherein the image processing device generates, based on the image data received from the imaging device, multispectral image data including pieces of image information each corresponding to one of the plurality of wavelength bands and transmits the multispectral image data to the imaging device, and
the controller adjusts the exposure based on a luminance value of the multispectral image data corresponding to the first wavelength band.

The present disclosure is applicable to a hyperspectral camera, for example.

What is claimed is:

1. An imaging device comprising:
a spectroscopic element that disperses incident light into more than three plurality of wavelength bands;
an image sensor that captures a subject image via the spectroscopic element to generate image data;
an input interface that receives first selection information indicating a first wavelength band selected by a user from the plurality of wavelength bands; and
a controller that adjusts exposure based on a luminance value of a piece of image information that is included in multispectral image data and corresponds to the first wavelength band, the multispectral image data including pieces of image information corresponding to the plurality of wavelength bands, respectively.

2. The imaging device according to claim 1, wherein
the multispectral image data is generated based on the image data, and
the controller acquires the multispectral image data and adjusts the exposure based on the luminance value included in the multispectral image data.

3. The imaging device according to claim 2, further comprising a processing circuit that generates the multispectral image data based on the image data.

4. The imaging device according to claim 1, wherein
the spectroscopic element is a filter array including a plurality of filters with different transmission spectra from each other, and
the multispectral image data is generated based on the image data and a restoration table determined based on a spatial distribution of the transmission spectra of the plurality of filters.

5. The imaging device according to claim 1, further comprising a display that displays a plurality of images indicated by the pieces of image information, respectively.

6. The imaging device according to claim 5, wherein, by receiving a user operation of selecting one or a plurality of images from the images displayed on the display, the input interface receives the first selection information indicating the first wavelength band selected by the user.

7. The imaging device according to claim 1, wherein
the light is incident on the spectroscopic element via an optical system,
the input interface receives second selection information indicating a second wavelength band selected by the user from the plurality of wavelength bands, and
the controller controls a focus position of the optical system based on the piece of image information that is included in the multispectral image data and corresponds to the second wavelength band.

8. An imaging method comprising:
generating image data by capturing a subject image via a spectroscopic element that disperses incident light into more than three plurality of wavelength bands;
receiving selection information indicating a first wavelength band selected by a user from the plurality of wavelength bands; and
adjusting exposure based on a luminance value of a piece of image information that is included in multispectral image data and corresponds to the first wavelength band, the multispectral image data including pieces of image information corresponding to the plurality of wavelength bands, respectively.

9. An imaging system comprising:
an imaging device; and
an image processing device communicably connected to the imaging device,
the imaging device including:
a spectroscopic element that disperses incident light into more than three plurality of wavelength bands;
an image sensor that captures a subject image via the spectroscopic element to generate image data;
a communication interface that sends the image data to the image processing device;
an input interface that receives first selection information indicating a first wavelength band selected by a user from the plurality of wavelength bands; and
a controller that adjusts exposure,
wherein the image processing device generates, based on the image data received from the imaging device, multispectral image data including pieces of image information each corresponding to one of the plurality of wavelength bands and transmits the multispectral image data to the imaging device, and
the controller adjusts the exposure based on a luminance value of the multispectral image data corresponding to the first wavelength band.
